(19) United States
(12) Patent Application Publication
(10) Pub. No.: US 2024/0232018 A1
(43) Pub. Date: Jul. 11, 2024

(54) INTENDED STATE BASED MANAGEMENT OF RISK AWARE PATCHING FOR DISTRIBUTED COMPUTE SYSTEMS AT SCALE

(71) Applicant: VMware, Inc., Palo Alto, CA (US)

(72) Inventors: Daniel James BEVERIDGE, Valrico, FL (US); Erol AYGAR, Maynard, MA (US)

(21) Appl. No.: 18/150,615

(22) Filed: Jan. 5, 2023

(51) Int. Cl. G06F 11/14; G06F 8/65; G06Q 10/0635

(52) U.S. Cl. CPC G06F 11/1433; G06F 8/65; G06Q 10/0635; G06Q 2220/00

(57) ABSTRACT

An example method of risk aware updating of an intended state configuration system is provided. The method generally includes determining, for each of one or more risk policies, for each of corresponding one or more compute stack entities associated with the risk policy, an update timing for updating the compute stack entity based on the risk policy. The method further includes modifying, for each compute stack entity of the plurality of compute stack entities, one or more manifest files at the determined update timing for updating the compute stack entity, wherein modifying the one or more manifest files causes the compute stack entity to be updated by a host monitoring the one or more manifest files.

Intended state configuration systems allow for uniform configuration, and seamless propagation of configuration changes to computing environments. For example, a configuration document, such as a manifest, defines configuration parameters for entities (also referred to as “compute stack entities”), such as applications, hypervisors, network entities, firmware, services, workloads, and/or the like running on computing infrastructure of a computing environment. As such, when a change is made to the configuration document, such as to apply updates (c.g., patches), thereby changing the intended state of the computing environment, the configuration changes are propagated to the computing environment, such that the computing environment is seamlessly updated to the intended state. For example, updates may be made to the entities running in the computing environment. The updates may add features, fix bugs, remedy vulnerabilities, update versions, or change the computing environment in some other manner.

As the scale and complexity of computing environments grow, so does the need for strategies for update management. In particular, there can be inherent risks with propagation of updates to the computing environment such as potential for outages, scale adoption of flawed or compromised configuration settings, patch level issues, etc. For example, software being updated, and any other software that relies upon the software being updated, will be unavailable during the update. Accounting for software being unavailable can be difficult, if not impossible, when large numbers of computing devices are involved and need to be updated. Therefore, handling patch management on those computing devices can still lead to undesired outages affecting the performance of activities by the computing devices in the aggregate. Accordingly, techniques are needed for balancing the efficiency of updates to intended state configuration systems with the risks involved with updating the computing environment.

It should be noted that the information included in the Background section herein is simply meant to provide a reference for the discussion of certain embodiments in the Detailed Description. None of the information included in this Background should be considered as an admission of prior art.

### SUMMARY

One or more embodiments provide a method of risk aware updating of compute stack entities in an intended state configuration system. The method includes receiving information of a plurality of compute stack entities. The method further includes receiving one or more group definitions defining one or more groups, each group of the one or more groups comprising one or more corresponding compute stack entities of the plurality of compute stack entities. The method further includes receiving information associating each of the one or more groups with a corresponding risk policy, cach risk policy defining one or more phases for updating compute stack entities associated with the risk policy. The method further includes determining. for each of the one or more risk policies, corresponding one or more compute stack entities associated with the risk policy based on the information of the plurality of compute stack entities, the one or more group definitions, and the information associating each of the one or more groups with a corresponding risk policy. The method further includes determining, for each of the one or more risk policies, for each of the corresponding one or more compute stack entities associated with the risk policy, an update timing for updating the compute stack entity based on the risk policy. The method further includes modifying, for each compute stack entity of the plurality of compute stack entities, one or more manifest files at the determined update timing for updating the compute stack entity, wherein modifying the one or more manifest files causes the compute stack entity to be updated by a host monitoring the one or more manifest files.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 is a block diagram of an exemplary container-based cluster according to aspects of the present disclosure.

FIG. 2 is a block diagram of an example computing environment for deploying and managing distributed containerized workloads according to aspects of the present disclosure.

FIG. 3 is a flow diagram illustrating example operations for managing risk aware updating of compute stack entities in an intended state configuration system according to aspects of the present disclosure.

FIG. 4 is a timeline illustrating example update timing for a plurality of compute stack entities according to aspects of the present disclosure.

FIG. 5 is a flow diagram illustrating example operations for determining update timing for a plurality of compute stack entities according to aspects of the present disclosure.

### DETAILED DESCRIPTION

Aspects of the present disclosure provide techniques for risk aware updating of intended state configuration systems. Though certain aspects are discussed with respect to a specific intended state configuration system for automatically deploying and/or managing containerized workloads at scale as an example, it should be noted that the techniques discussed herein may similarly be used for risk aware updating of other intended state configuration systems, such as for other types of computing environments, including non-containerized systems. In particular, certain aspects relate to incorporating risk assessment into the intended state configuration system itself, so that the intended state configuration system updates the computing environment based on a schedule according to the risk assessment.

In certain aspects, a computing environment may include a plurality of compute stack entities that are managed by an intended state configuration system. A compute stack entity is an entity that is managed separately from other entities in an intended state configuration system. For example, a hypervisor running on a physical computing device (c.g., referred to as a host machine) may be a compute stack entity. Further, different hypervisors running on different host machines may be different compute stack entities. Other example types of compute stack entities include system firmware (e.g., host firmware), hypervisor, device firmware (e.g., storage device, network device, etc.), application runtimes (e.g., in Kubernetes®), load balancers, supporting cross-application elements such as key-value stores, virtual storage systems, specific applications, other software, and/or the like.

More generally, a compute stack entity is one of several technologies of the overall functional computing environment, and is a distinct technology with dependencies on other technology layers or hardware and which needs to be managed separately from other layers in the compute stack. Each separate compute stack entity may have its own dependencies, its own API or control surface, method of management, and risk profile within the overall computing environment.

Each compute stack entity may be on a particular physical host machine. Further, a compute stack entity may be identified by a unique identifier, which in an example, is any combination or concatenation of <host id>, <stack type>, <entity id>. The <host id>is an identifier of the physical host machine where the compute stack entity runs or is located. The <stack type>refers to a type of the compute stack entity (e.g., system firmware, hypervisor, etc.). The <entity id>refers to a unique identifier, such as a universally unique identifier (UUID), associated with the compute stack entity. In the case of a hypervisor, for example, it may be a UUID of the hypervisor. In the case of firmware, it may be an identifier of the hardware associated with the firmware, such as a device ID or host ID.

Further, one or more groups may be defined, each group including a plurality of compute stack entities. Such groups may be formed automatically, such as by defining groups based on compute stack entities with shared attributes, such as of the same type, in the same geographical location, associated with the same business unit, associated with the same company, version number, and/or the like. For example, a group for all hypervisors may be created and automatically include all compute stack entities with a <stack type>hypervisor. In another example, a group for all hypervisors in the USA may be created and automatically include all compute stack entities with a <stack type>hypervisor running on a host geographically located in the USA. In another example, a group for all hypervisors of version 6 may be created and automatically include all compute stack entities with a <stack type>hypervisor and that hypervisor is version 6 of the software. As another example, a group of all hypervisors and firmware may be created, and automatically include all compute stack entities with a <stack type>hypervisor or firmware. Additionally or alternatively, compute stack entities may be manually added to groups.

Further, a group may be associated with a risk policy. A risk policy defines one or more phases for propagating updates among the compute stack entities within the group. For example, a risk policy may indicate that a certain number or percentage of compute stack entities within the group should be updated in each phase. As an example, in a first phase, the risk policy may indicate to update 5% of the compute entities in a group, in phase 2—20%, in phase 3—70%, and in phase 4—5%. Further, a time delay may be specified between the end of a phase and a start of a next phase (e.g., the same delay between each phase or different delays for different phases). In certain aspects, the time delay may be modified based on triggers or events that occur before the start of a phase.

Updating compute stack entities in phases rather than all at once may help avoid disruptions caused by a bad update (e.g., an update that includes a bug). For instance, if all systems providing a particular service are updated and that update prevents the systems from effectively providing the service, then the service is unavailable until the issue caused by the update is resolved. Thus, only updating a portion of the systems enables other systems providing the service to continue operating having not received the update. Should the update prove to be reliable, then the other systems can be updated as well. Similarly, updates to systems supporting more important activities (i.c., higher risk systems) may be performed after the updates have already proven themselves to be stable.

In certain aspects, a particular compute stack entity may be associated with more than one group. Accordingly, groups may be prioritized, such that should a compute stack entity be associated with more than one group, it is updated based on the risk policy associated with the group having the highest priority that it is associated with. For example, a compute stack entity may be a part of a first group and a second group. If the first group has priority over the second group, the compute stack entity is updated according to the risk policy associated with the first group, as opposed to according to the risk policy associated with the second group.

In certain aspects, a compute stack entity is assigned a risk score, such as based on attributes associated with the compute stack entity and/or the groups it is a member of, such as related to a degree of business risk associated with outage for each instance of the compute stack entity. In certain aspects, compute stack entities with a lower risk score in a group are updated as part of earlier phases, and compute stack entities with a higher risk score in a group are updated as part of later phases of update to the group.

As a non-limiting example of a risk score calculation, in certain aspects, the risk score for a compute stack entity may be calculated as the average of the stack entity risk score and the max value of all the group membership risk scores of the compute stack entity. For example, a compute stack entity may be running version 1.6, which has a score of x, may be a member of a particular business unit, which has a score of y, and may be located in North America, which has a score of z, such that the risk score is calculated as average (x+max (y, z)).

In certain aspects, a management component establishes membership of compute stack entities to groups, and further schedules the update of such compute stack entities within an intended state configuration system according to the risk policies assigned to the groups. In particular, in certain aspects, the management component may determine that a first set of compute stack entities in a first group are to be updated in a first time interval corresponding to a first phase of a risk policy associated with the first group. Further, the management component may determine that a second set of compute stack entities in the first group are to be updated in a second time interval corresponding to a second phase of a risk policy associated with the first group. In order to start the first phase, the management component may update configuration parameters in one or more manifests associated with the first set of compute stack entities. The intended state configuration system, based on the updated one or more manifests, may then automatically propagate the updates to the first set of compute stack entities.

In certain aspects, the management component may further be capable of updating compute stack entities that are not part of an intended state configuration system, but nonetheless are added to one or more groups. For example, the management component may directly push an update to such a compute stack entity to the physical host machine the compute stack entity runs on, as opposed to updating configuration parameters in one or more manifests to update the compute stack entity. Additional details of updating entities separate from an intended state configuration system are disclosed in U.S. application Ser. No. 17/863,727, filed on Jul. 13, 2022, and titled “OPTIMIZED DEPLOYMENT OF UPDATES ACROSS COMPUTING SYSTEMS CONNECTED TO A WIDE AREA NETWORK (WAN),” which is hereby incorporated by reference herein in its entirety. Accordingly, in certain aspects, a management component as discussed herein may flexibly be able to manage the update multiple different types of systems.

Some aspects herein are discussed with respect to an intended state configuration system for managing containerized workloads. A container is a package that relies on virtual isolation to deploy and run applications that access a shared operating system (OS) kernel. Containerized applications, also referred to as containerized workloads, can include a collection of one or more related applications packaged into one or more groups of containers, referred to as pods, that can be deployed based on the context defined in a manifest for the containerized workloads. Each pod may include one or more containers.

Containerized workloads run on a container orchestration platform that enables the automation of much of the operational effort required to run containers having workloads and services. This operational effort includes a wide range of things needed to manage a container's lifecycle, including, but not limited to, provisioning, deployment, scaling (up and down), networking, and load balancing.

Kubernetes® (K8S®) software is an example open-source container orchestration platform that automates the operation of such containerized workloads. Kubernetes software allows for distributed computing by running the pods of containerized workloads on a cluster of interconnected worker nodes (e.g., virtual machines (VMs) or physical machines) that may scale vertically and/or horizontally over hybrid cloud topology.

In certain aspects, a software-defined data center (SDDC) includes clusters of physical servers (e.g., hosts) that are virtualized and managed by virtualization management servers. A host can include a virtualization layer (e.g., a hypervisor) that provides a software abstraction of the hardware platform of the physical server (e.g., central processing unit (CPU), random access memory (RAM), storage, network interface card (NIC), etc.) to allow multiple virtual computing instances (e.g., such as VMs) to run thereon. A control plane for each cluster of hosts may support the deployment and management of applications (or services) on the cluster using containers. In some cases, the control plane deploys applications as pods of containers running on one or more worker nodes. Though certain aspects are described herein with respect to VMs as worker nodes, other suitable types of VCIs, and/or hardware nodes may similarly be used as worker nodes.

Some aspects herein are discussed with respect to an intended state configuration system for automatically deploying and/or managing containerized workloads. In certain aspects, the containerized workloads may be distributed. Automated deployment refers to the automation of steps, processes, and/or activities that are necessary to make a system and/or update available to its intended users. Automation of much of the operational effort required to set up and/or manage a system capable of supporting containerized workloads is based on an ability of the system to access one or more intended state configuration files made up of one or more manifests that declare intended system infrastructure and workloads to be deployed in the system. In certain aspects, the manifests are JavaScript Object Notation (JSON) and/or YAML files. Additional details of an intended state configuration system for automatically deploying and/or managing containerized workloads are disclosed in U.S. application Ser. No. 63/403,267, filed on Sep. 1, 2022, and titled “OPTIMIZED SYSTEM DESIGN FOR DEPLOYING AND MANAGING CONTAINERIZED WORKLOADS AT SCALE,” which is hereby incorporated by reference herein in its entirety.

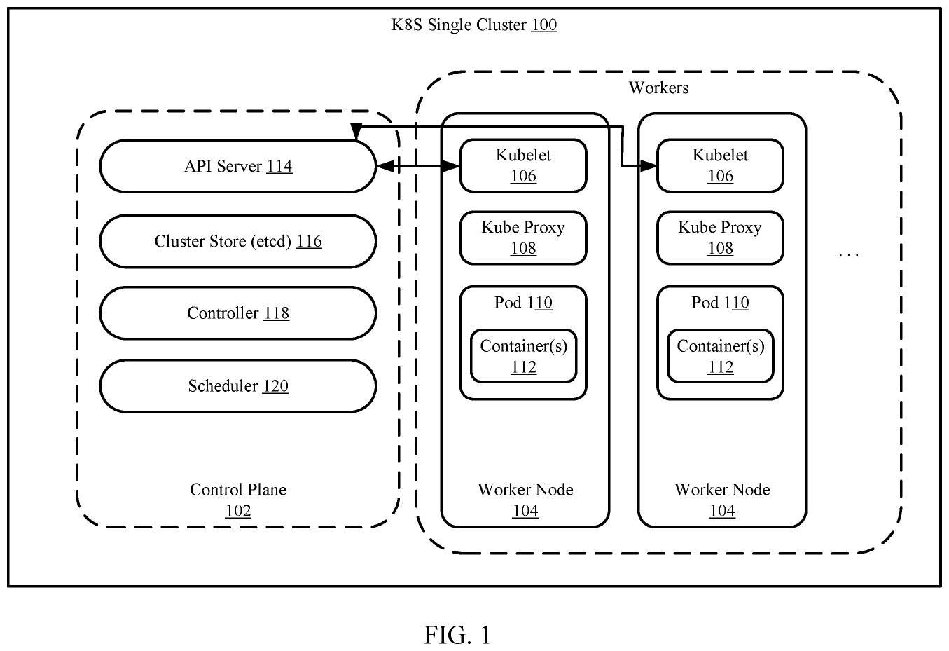

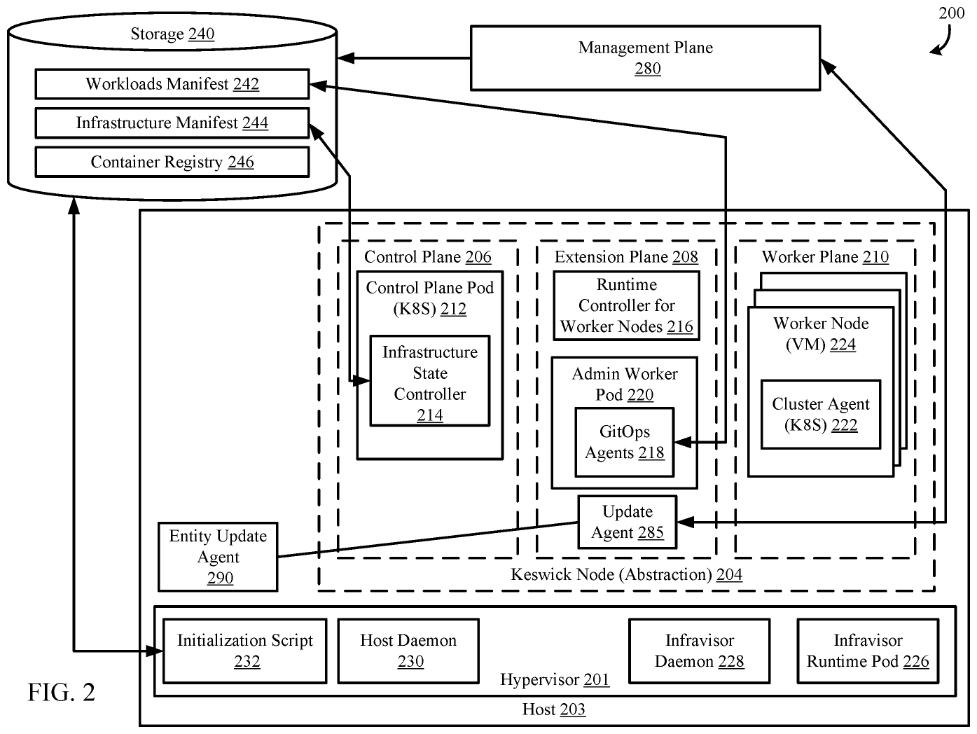

Turning now to FIG. 1, a block diagram of an exemplary container-based cluster is illustrated. It should be noted that the block diagram of FIG. 1 is a logical representation of a container-based cluster, and does not show where the various components are implemented and run on physical systems. FIG. 2 provides an example system for implementing and running a container-based cluster of FIG. 1. While the example container-based cluster shown in FIG. 1 is a Kubernetes cluster 100, in other examples, the container-based cluster may be another type of container-based cluster based on container technology, such as Docker® clusters.

When Kubernetes is used to deploy applications, a cluster, such as K8S cluster 100 illustrated in FIG. 1, is formed from a combination of worker nodes 104 and a control plane 102. Worker nodes 104 are managed by control plane 102, which manages the computation, storage, and memory resources to run all worker nodes 104.

Each worker node 104, or worker compute machine, includes a kubelet 106, which is an agent that ensures that one or more pods 110 run in the worker node 104 according to a defined specification for the pods, such as defined in a workload definition manifest. Each pod 110 may include one or more containers 112. The worker nodes 104 can be used to execute various applications and software processes using container 112. Further each worker node 104 includes a kube proxy 108. Kube proxy 108 is a Kubernetes network proxy that maintains network rules on worker nodes 104. These network rules allow for network communication to pods 110 from network sessions inside and/or outside of K8S cluster 100.

Control plane 102 includes components such as an application programming interface (API) server 114, a cluster store (etcd) 116, a controller 118, and a scheduler 120. Control plane 102′s components make global decisions about K8S cluster 100 (e.g., scheduling), as well as detect and respond to cluster events (e.g., starting up a new pod 110 when a workload deployment's replicas field is unsatisfied).

API server 114 operates as a gateway to K8S cluster 100. As such, a command line interface, web user interface, users, and/or services communicate with K8S cluster 100 through API server 114. One example of a Kubernetes API server 114 is kube-apiserver. kube-apiserver is designed to scale horizontally-that is, this component scales by deploying more instances. Several instances of kube-apiserver may be run, and traffic may be balanced between those instances.

Cluster store (etcd) 116 is a data store, such as a consistent and highly-available key value store, used as a backing store for all K8S cluster 100 data.

Controller 118 is a control plane 102 component that runs and manages controller processes in K8S cluster 100. For example, control plane 102 may have (c.g., four) control loops called controller processes, which watch the state of cluster 100 and try to modify the current state of cluster 100 to match an intended state of cluster 100. In certain aspects, controller processes of controller 118 are configured to monitor external storage for changes to the state of cluster 100.

Scheduler 120 is a control plane 102 component configured to allocate new pods 110 to worker nodes 104. Additionally, scheduler 118 may be configured to distribute resources and/or workloads across worker nodes 104. Resources may refer to processor resources, memory resources, networking resources, and/or the like. Schedule 118 may watch worker nodes 104 for how well cach worker node 104 is handling their workload, and match available resources to the worker nodes 104. Scheduler 118 may then schedule newly created containers 112 to one or more of the worker nodes 104.

In other words, control plane 102 manages and controls every component of the cluster 100. Control plane 102 handles most, if not all, operations within cluster 100, and its components define and control cluster 100′s configuration and state data. Control plane 102 configures and runs the deployment, management, and maintenance of the containerized applications. As such, ensuring high availability of the control plane may be critical to container deployment and management. High availability is a characteristic of a component or system that is capable of operating continuously without failing.

Accordingly, in certain aspects, control plane 102 may operate as a high availability (HA) control plane. Additional details of HA control planes are disclosed in U.S. application Ser. No. 63/347,815, filed on Jun. 1, 2022, and titled “AUTONOMOUS CLUSTERS IN A VIRTUALIZATION COMPUTING ENVIRONMENT,” which is hereby incorporated by reference herein in its entirety.

As mentioned, while container orchestration platforms, such as Kubernetes, provide automation to deploy and run clusters of containerized applications (e.g., such as K8S cluster 100 illustrated in FIG. 1), thereby allowing for casy scalability of containers based on application requirements, containers are not the only part of the software stack that needs to be automated for scaling. For example, deployment of a control plane (e.g., such as control plane 102 illustrated in FIG. 1) may be necessary for the deployment and management of such containerized workloads.

FIG. 2 is a block diagram of a computing environment 200 for deploying and managing distributed containerized workloads. The architecture of environment 200 described in FIG. 2 may allow for implementation of a container-based cluster on a hypervisor. For example, a logical construct of K8S cluster 100 illustrated in FIG. 1 may be implemented by the architecture described below with reference to FIG. 2. Though only one physical host machine 203 is shown in computing environment 200, it should be noted that computing environment 200 may include additional physical host machines.

As mentioned, a hypervisor is a type of virtualization software that supports the creation and management of virtual endpoints by separating a physical machine's software from its hardware. In other words, hypervisors translate requests between physical and virtual resources, thereby making virtualization possible. When a hypervisor is installed directly on the hardware of a physical machine, as opposed to on top of an operating system (OS) of the machine, the hypervisor is referred to as bare-metal hypervisor. In certain aspects, hypervisor 201 illustrated in FIG. 2 is a bare-metal hypervisor. As shown, a host 203 runs hypervisor 201. Host 203 is a physical computing device, such as a server-grade computer, that includes hardware components, such as a memory, processor, storage, networking card, and/or the like, for running components described herein.

In certain aspects, a user interface (not shown) may be provided to enable users to interact with hypervisor 201, such as to check on system status, update configuration, etc. The user interface may be accessible by directly accessing host 203, or by accessing host 203 over a network, such as via machine web browser or API client. For example, hypervisor 201 may include a host daemon 230 running as a background process, which in part allows connection to hypervisor 201 for monitoring hypervisor 201.

In certain aspects, hypervisor 201 is a multi-layer entity, where each layer is provided a different level of privilege. In particular, hypervisor 201 architecture may include underlying OS features, referred to as a kernel, and processes that run on top of the kernel. The kernel may be a microkernel that provides functions such as process creation, process control, process threads, signals, file system, etc. A process running on or above the kernel may be referred to as a “user world” process. A user world process may run in a limited environment. A privilege level of the kernel may be greater than a privilege level of a user world process.

Hypervisor 201, as part of an infravisor layer, may include an infravisor daemon 228 running as a background process. In certain aspects, infravisor daemon 228 is an infravisor watchdog running on hypervisor 201. The infravisor daemon 228 is configured to monitor individual infravisor services (e.g., including an infravisor runtime pod 226, described in detail below) running in a cluster of hosts to help guarantee that a minimum number of individual services are continuously running in the cluster. In certain aspects, infravisor daemon 228 monitors an API server (e.g., such as API server 114 illustrated in FIG. 1) to determine whether a minimum number of individual services are running.

Hypervisor 201, as part of an infravisor layer, may further include an infravisor runtime pod 226, which may be a pod of containers running on the hypervisor 201 that execute control plane entities, such as API server 114, cluster store (etcd) 116, controller 118, and scheduler 120 illustrated in FIG. 1, for a cluster of hosts. These components may run as separate or consolidated pods for isolation or footprint reduction, respectively. The infravisor runtime pod 226 may access the cluster store (etcd) 116 to store a cluster's runtime state. In certain aspects, the infravisor runtime pod 226 is bootstrapped on a host in a cluster when the infravisor daemon 228 detects the absence of a functional infravisor runtime pod. It should be noted that such control plane functionality provided by infravisor runtime pod 226 may be separate from the control plane 206 described herein for worker nodes. In particular, while infravisor runtime pod 226 and a control plane pod 212 of control plane 206 may execute similar control plane/runtime entities, in certain aspects, the infravisor runtime pod 226 runs in a higher privilege level than control plane pod 212 of control plane 206. Further, while infravisor runtime pod 226 may manage at least part of the lifecycle of pods or services for running containerized workloads, control plane pod 212 of control plane 206 manages the runtime state of such containerized workloads, and the infrastructure necessary for implementation.

Hypervisor 201 provides resources of host 203 to run one or more pods or services, collectively referred to as a Keswick node 204, which is a logical abstraction of the one or more pods or services. (The term, “Keswick” is an arbitrary name given to the abstraction for purpose of easy reference.) The pods and services of the Keswick node 204 are logically separated by function into a control plane 206, an extension plane 208, and a worker plane 210, which are used to provide services for deploying and/or managing containerized workloads.

Control plane 206 includes a control plane pod 212, which may be a pod of containers running on the hypervisor 201 that execute control plane entities, such as API server 114, cluster store (etcd) 116, controller 118, and scheduler 120 illustrated in FIG. 1, for worker nodes 224. The control plane pod 212 runs an infrastructure state controller 214 configured to manage the state of control plane 206, such as a number of worker nodes 224 to run, networking configuration of such worker nodes 224, etc. In certain aspects, control plane 206 is configured based on infrastructure manifest 244 stored in storage 240.

Infrastructure manifest 244 provides information about intended system infrastructure to be deployed on host 203. For example, infrastructure manifest 244 may define the infrastructure on which containerized workloads are expected to run. This may include information about a number of worker VMs 224 to instantiate, assignment of hardware resources to worker VMs 224, software configuration (e.g., a version of Kubernetes an application/workload uses), and/or network infrastructure (e.g., a software defined network). As an illustrative example, the infrastructure manifest 244 may indicate a number of worker node VMs to deploy on hypervisor 201 and, in some cases, images to use for instantiating each of these worker node VMs. The number of worker node VMs indicated in infrastructure manifest 244 may be a number of worker node VMs needed to run particular workloads defined in a workloads manifest 242.

In certain aspects, infrastructure manifest 244 is included in an intended state configuration file. In certain aspects, the intended state configuration file may include one or more other manifests (e.g., such as workloads manifest 242). The intended state configuration file may be stored in storage 240, which may be an external storage that is accessible by hypervisor 201. Storage 240 may further be accessible by infrastructure state controller 214 of control plane 206 after the control plane is instantiated, such as to monitor for updates to the infrastructure manifest 244 and automatically update the configuration of control plane 206, accordingly. In certain aspects, storage 240 is a repository on a version control system. As mentioned previously, one example version control system that may be configured and used in aspects described herein is GitHub made commercially available by GitHub, Inc.

As such, hypervisor 201 may be configured to pull information from infrastructure manifest 244 and use this information to instantiate and configure control plane 206, such as by instantiating and configuring control plane pod 212. In certain aspects, this involves instantiating worker plane 210 by deploying one or more worker node VMs 224 in worker plane 210. A number of worker node VMs 224 deployed in worker plane 210 may be based, at least in part, on a number of work node VMs indicated for deployment in infrastructure manifest 244.

Infrastructure state controller 214 on control plane 206 is configured to manage a state of the infrastructure. In other words, infrastructure state controller 214 accepts an “intended state” (also referred to as “desired state” or “declared state”) via infrastructure manifest 244, observes the state of the infrastructure, and dynamically configures the infrastructure such that the infrastructure matches the “intended state.” Accordingly, infrastructure state controller 214 may also be configured to interact with infrastructure manifest 244 stored in storage 240.

Further, in certain aspects, infrastructure state controller 214 monitors storage 240 for changes/updates to infrastructure manifest 244. Infrastructure state controller 214 may be configured to dynamically update the infrastructure such that the infrastructure matches a new “intended state” defined by infrastructure manifest 244, for example, when infrastructure state controller 214 determines infrastructure manifest 244 has been updated.

Worker node VMs 224 deployed in worker plane 210 are compute resources that use software to run programs and deploy applications/workloads. More specifically, worker node VMs 224 may be used to deploy containerized workloads on hypervisor 201. Worker node VMs 224 deployed in worker plane 210 may each include a cluster agent 222. A cluster agent 222 may be a container or a pod within a worker node VM 224. In certain aspects, cluster agent 222 is configured to monitor the health of a container-based cluster supported via worker node VM 224. Further, in certain aspects, cluster agent 222 is configured to collect metrics and metadata for a container-based cluster deployed on worker node VM 224, including each node and namespace down to the container level. As shown in FIG. 2, worker plane 210 is isolated from control plane 206; thus, worker node VMs 224 and their corresponding cluster agents 222 are similarly isolated from control plane 206. Worker plane 210 describes resources managed by hypervisor 201 dedicated for running VMs. These resources may be distinct from resources used to run control plane 206 and extension plane 208.

Extension plane 208 includes a runtime controller for worker nodes 216 and an admin worker pod 220 which includes GitOps agents 218. In certain aspects, GitOps agents 218 are configured to interact with workloads manifest 242 stored in storage 240.

Workloads manifest 242 provides information about intended workloads to be deployed in hypervisor 201. For example, workloads manifest 242 may outline details of one or more workloads to be deployed in worker node VMs 224 in worker plane 210 on hypervisor 201. In particular, in certain aspects, workloads manifest 242 includes an identifier of a binary to be loaded. In certain aspects, workloads manifest 242 includes information about resources to be deployed, workload parameters associated with these resources, and/or protected resources for one or more workloads. The workload parameters may include a workload name, a workload ID, a service name, an associated organization ID, and/or the like.

In certain aspects, workloads manifest 242 is included in an intended state configuration file. In some cases, the intended state configuration file may include one or more other manifests (e.g., such as infrastructure manifest 244). The intended state configuration file may be stored in storage 240 which is external storage that is accessible by GitOps agents 218.

As such, GitOps agents 218 may be configured to pull information from workloads manifest 242 and use this information to instantiate workloads on worker node VMs 224 running in worker plane 210 (e.g., previously deployed by control plane 206).

Runtime controller for worker nodes 216 is configured to manage a state of the worker node VMs 224. In other words, runtime controller for worker nodes 216 accepts an “intended state” (also referred to as “intended stated” or “declared state”) from workloads manifest 242, observes the state of the worker node VMs 224, and dynamically configures the worker node VMs 224 such that their behavior matches the “intended state.”

Further, in certain aspects, runtime controller for worker nodes 216 monitors storage 240 for changes/updates to workloads manifest 242. Runtime controller for worker nodes 216 may be configured to dynamically update the state of the worker node VMs 224 to match a new “intended state” defined by workloads manifest 244, for example, when runtime controller for work nodes 216 determines workloads manifest 244 has been updated.

As mentioned, in certain aspects, privilege becomes diluted when moving from bottom to top layers of hypervisor 201. As such, in certain aspects, the infravisor layer of hypervisor 201 is at a lower, more privileged level of hypervisor 201, while control plane 206 and extension plane 208 are at a lesser-privileged level in hypervisor 201. Additionally, the worker node VMs 224 running in worker plane 210 may be on top of hypervisor 201, as this is where the deployed workloads are expected to run.

Further, in addition or alternative to different privilege levels, defined management levels may be assigned to different entities. For example, in certain aspects, worker node VMs 224 are managed by control plane pod 212 of control plane 206, and the control plane pod 212 is managed by the infravisor layer of hypervisor 201.

It should be noted that Keswick Node 204 is a logical abstraction that represents the control plane 206, extension plane 208, and worker plane 210. Though certain example implementations are described herein of how each of the control plane 206, extension plane 208. and worker plane 210 are implemented (e.g., as pods, VMs, etc.) and where they run (e.g., in hypervisor 201, on top of hypervisor 201, etc.), it should be noted that other implementations may be possible, such as having certain components run in different privilege levels, layers, within hypervisor 201, outside hypervisor 201, etc.

Further, as shown in FIG. 2, hypervisor 201 includes an initialization script 232. Initialization script 232 is a sequence of instructions that are interpreted or carried out during startup of hypervisor 201. Initialization script 232 helps to automate the deployment of hypervisor 201 and Keswick node 204. In other words, initialization script 232 helps to automate and streamline the deployment of containerized workloads on hypervisor 201.

In certain aspects. initialization script 232 may interact with container registry 246 available in storage 240. Container registry 246 may be a repository. or a collection of repositories, used to store and access container images. Although container registry 246 is illustrated as being stored in storage 240 with workloads manifest 242 and infrastructure manifest 244, in certain other aspects, container registry may be stored separately from one or both of these manifests.

Further, shown in FIG. 2, is a management plane 280, which is an example of a management component for managing updating and patching compute stack entities of the environment 200. In certain aspects, the management plane 280 may be implemented as a single entity (e.g., running on a physical or virtual compute instance), or as a distributed or clustered application or components, such as one or more pods. The management plane 280 is configured to manage and provide risk aware updating of environment 200, as discussed herein.

For example, management plane 280 may be configured to determine the compute stack entities running in environment 200. In certain aspects, for each host 203, management plane 280 interacts with an update agent 285 on host 203. In an example, update agent 285 is running in extension plane 208 of Keswick node 204, however the update agent 285 may run in other locations. The management plane 280 may interact with the update agent 285 to determine the compute stack entities running on the host 203. For example, management plane 280 may send a query message over a network to host 203, requesting a list of compute stack entity identifiers (e.g., <host id><stack type><entity id>) of compute stack entities running on host 203. The update agent 285 running on the host 203 may determine the compute stack entities running on the host 203, such as through interaction with hypervisor 201 and/or other components. In certain aspects, update agent 285 further determines one or more attributes of each of the compute stack entities running on the host 203. The update agent 285 responds to the query from management plane 280 and provides the compute stack entity identifiers, and in certain aspects, attributes associated with the compute stack entities identified by the compute stack entity identifiers.

Management plane 280 may further be configured to receive, such as from an administrator via a graphical user interface (GUI), one or more group definitions of one or more groups, cach group definition defining the compute stack entities to be included in the group as discussed. Management plane 280 may further be configured to receive, such as from the administrator via the GUI, one or more risk policy definitions defining one or more risk policies and one or more risk policy associations defining associations between the one or more risk policies and the one or more groups. Each group may be associated with one risk policy. Further, different groups may be associated with different risk policies. In certain aspects, some groups may be associated with the same risk policy. In certain aspects, cach group is associated with a distinct risk policy.

Management plane 280 may further be configured to receive, such as from the administrator via the GUI, group prioritization information indicating a priority between groups, which may be used to determine which risk policy to use to update a particular compute stack entity when the compute stack entity belongs to multiple groups, as discussed.

Accordingly, using the information regarding compute stack entities (c.g., and their attributes), group definitions, risk policy definitions, and group to risk policy associations, (and optionally group membership prioritization information) management plane 280 is configured to control/manage risk aware updating of compute stack entities in environment 200.

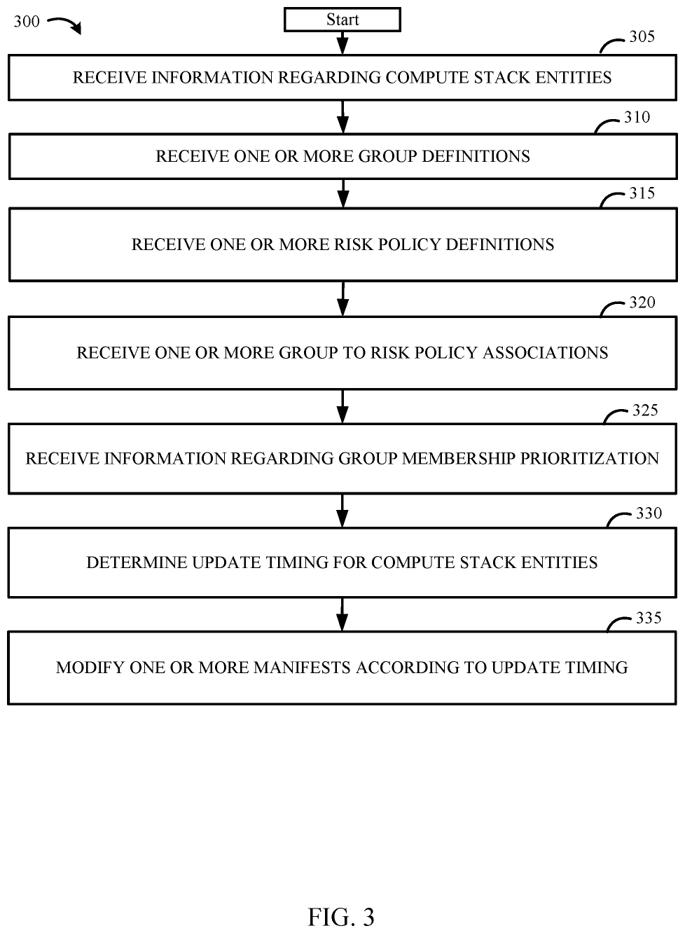

FIG. 3 is a flow diagram illustrating example operations 300 for managing risk aware updating of compute stack entities in an intended state configuration system.

At block 305, a management component receives information regarding a plurality of compute stack entities in a computing environment. Management plane 280 is an example of the management component. For example, management plane 280 receives for each of the plurality of compute stack entities, a compute stack entity identifier and one or more attributes of the compute stack entity. Management plane 280 may receive the information from one or more update agents 285 on one or more hosts 203.

At block 310, management component receives information regarding one or more group definitions defining one or more groups, each group comprising one or more corresponding compute stack entities of the plurality of compute stack entities. For example, management plane 280 receives the information from an administrator.

At block 315, management component receives information regarding one or more risk policy definitions. In certain aspects, each risk policy definition defines one or more phases for updating compute stack entities. For example, management plane 280 receives the information from an administrator.

At block 320, management component receives information regarding one or more group to risk policy associations. In certain aspects, cach group to risk policy association associates a risk policy of the one or more risk policies with a group of the one or more groups. For example, management plane 280 receives the information from an administrator.

At block 325, management component receives information regarding group membership prioritization. For example, management plane 280 receives the information from an administrator.

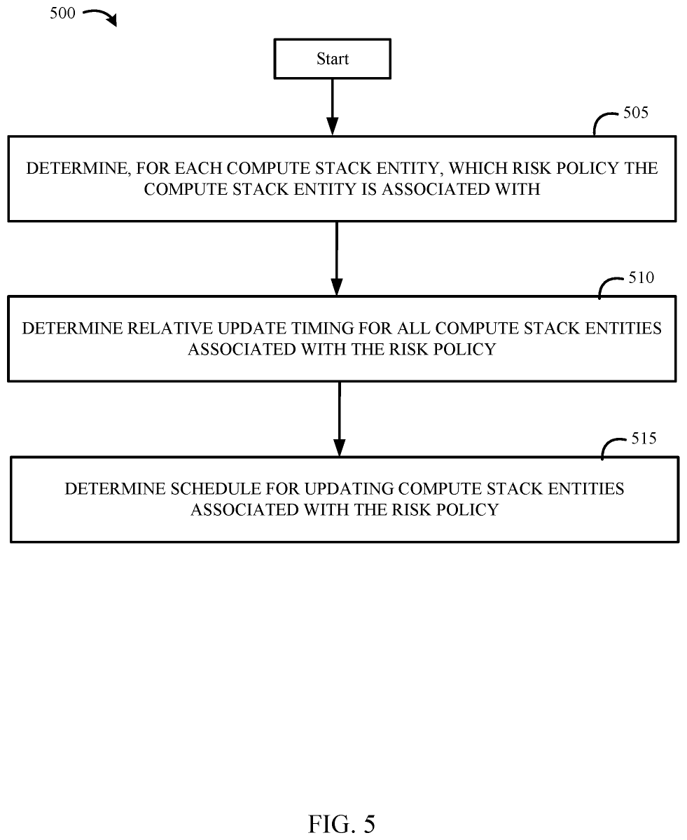

At block 330, management component determines update timing for the plurality of compute stack entities based on the information received at blocks 305-325. In certain aspects, the update timing is determined using any suitable technique, such as described in U.S. application Ser. No. 17/863,727 incorporated by reference herein. One example technique is described further herein with respect to FIG. 5.

At block 335, management component modifies one or more manifests according to the determined update timing, such that the plurality of compute stack entities are automatically updated according to the determined update timing. In particular, the configuration of cach compute stack entity of the plurality of compute stack entities is defined in the one or more manifests. The defined configuration for each given compute stack entity is modified in the one or more manifests by the management component at the corresponding time defined for updating the compute stack entity, such as within a particular time window. The physical host running a given compute stack entity determines the modified configuration for the given compute stack entity and updates the given compute stack entity, at the corresponding time for updating the compute stack entity, based on the defined configuration for the given compute stack entity being modified at the corresponding time.

For example, management plane 280 updates workloads manifest 242 and/or infrastructure manifest 244 according to the determined update timing. In certain aspects, management plane 280 updates workloads manifest 242 for compute stack entities defined in workloads manifest 242. In certain aspects, management plane 280 updates infrastructure manifest 244 for compute stack entities defined in infrastructure manifest 244. Further, as discussed, infrastructure control 214 and admin worker pod 220 on each of one or more hosts 203, based on the updates to workloads manifest 242 and/or infrastructure manifest 244, update compute stack entities on their respective host 203. In certain aspects, infrastructure control 214 and admin worker pod 220 may update compute stack entities directly, such as if they have the correct privileges to update the compute stack entities. In certain aspects, for one or more compute stack entities, infrastructure control 214 and/or admin worker pod 220 may interact with (c.g., send a message to) one or more entity update agents 290 (e.g., a BIOS update agent for updating a BIOS, a patch manager for a hypervisor, a firmware manager for hardware, etc.) on host 203. Accordingly, the one or more entity update agents 290 may update one or more compute stack entities. An entity update agent 290 may have a privilege level that allows it to update one or more types of compute stack entities. For example, an entity update agent 290 may have one or more subcomponents, such as a command line interface (CLI), that allow it to update the one or more types of compute stack entities.

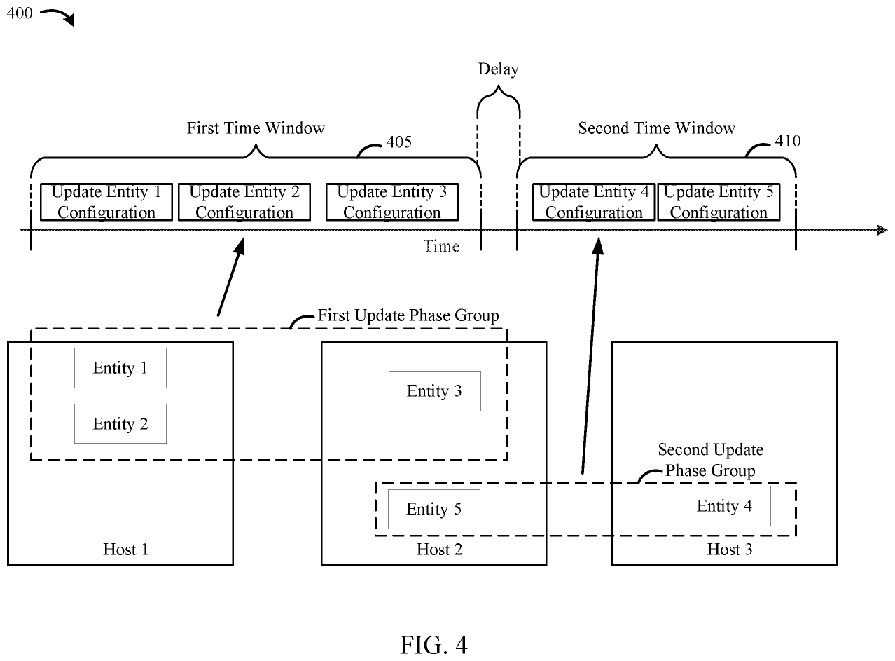

FIG. 4 is a timeline 400 illustrating example update timing for a plurality of compute stack entities according to aspects of the present disclosure. In an illustrative example, assume compute stack entity 1 running on host 1, compute stack entity 2 running on host 1, and compute stack entity 3 running on host 2 are associated with a first update phase. Further, assume compute stack entity 4 running on host 3 and compute stack entity 5 running on host 2 are associated with a second update phase. During a first time window 405 associated with the first update phase, management plane 280 updates entries in workloads manifest 242 and/or infrastructure manifest 244 corresponding to compute stack entities 1-3. For example, infrastructure state controller 214 and/or admin worker pod 220 on host 1, determine updated entries for compute stack entities 1 and 2 during the first time window, and accordingly update the configuration of compute stack entities 1 and 2 to correspond to the updated entries. Further, infrastructure state controller 214 and/or admin worker pod 220 on host 2, determine an updated entry for compute stack entity 3 during the first time window, and accordingly update the configuration of compute stack entity 3 to correspond to the updated entry.

Further, during a second time window 410 associated with the second update phase, management plane 280 updates entries in workloads manifest 242 and/or infrastructure manifest 244 corresponding to compute stack entities 4 and 5. For example, infrastructure state controller 214 and/or admin worker pod 220 on hosts 3 and 2, determine updated entries for compute stack entities 4 and 5, respectively, during the second time window, and accordingly update the configuration of compute stack entities 4 and 5, respectively, to correspond to the updated entries.

As shown, there may be a delay between first time window 405 and second time window 410. For example, there may be a delay between the end of a first update phase and the start of a next update phase, such as to allow time to see if the first update phase caused any issues with the functionality of the updated compute stack entities. Accordingly, if issues do arise, subsequent update phases can be halted before they begin, to avoid causing further issues with additional compute stack entities. Further, though update phases are shown as occurring serially, in certain aspects, update phases may occur at least partially in parallel, such as the time windows for two update phases starting at the same time, or a second update phase time window starting after a first update phase time window starts, but prior to the end of the first update phase time window.

Accordingly, the compute stack entities in the intended state configuration system are updated according to the risk policies defined for the compute stack entities.

In certain aspects, as discussed, the management component is also configured to update compute stack entities directly, such as those not managed by an intended state configuration system. For example, a compute stack entity not managed by an intended state configuration system may be associated with a same risk policy as one or more other compute stack entities associated with an intended state configuration system. Accordingly, the management component may similarly determine the update timing for the compute stack entity, but instead of updating a manifest at the determined update time for the compute stack entity, instead push the update directly to the compute stack entity, such as to the host running the compute stack entity. For example, management plane 280, at the determined update time, may send an update to host 203 to perform for the compute stack entity on host 203. In certain aspects. management plane 280 sends the update to update agent 285, which directly updates the compute stack entity. In certain aspects, update agent 285, receiving the update, interacts with an entity update agent 290 to effectuate the update, as discussed.

In certain aspects, management component 280 is configured to log updates made in a blockchain ledger. Accordingly, this protects against nonrepudiation of the update, such that if the update is made, it will be known the update is made as the record of the update blockchain cannot be removed from the blockchain ledger. Therefore auditing of updates is ensured to be accurate.

In certain aspects, management component 280 is configured to get authorization, such as from multiple parties, before making an update. In particular, as updates made by management component 280 can be on a large scale, it may be important to provide checks that the updates do not cause malicious behavior, such as introduce ransomware, delete important data, etc. Accordingly, in certain aspects, such as for certain types of update operations (e.g., as indicated in a designated list), management component 280 is configured to get authorization before starting the described update process. In certain aspects, management component 280 uses authorization from the blockchain by way of smart contract execution, requiring multiple parties to write to a blockchain acting as a smart contract that the update is authorized. Management component 280 may therefore only start the update process for the update when it reads the blockchain smart contract and determines the requisite authorization(s) are included.

In certain aspects, update agent 285 on host 203 is configured to determine the progress of the update of compute stack entities on the host 203 and send such progress information back to management plane 280. For example, the update agent 285 may determine which compute stack entities have completed update, what percentage of compute stack entities associated with a given update phase have been updated, what number of compute stack entities associated with a given update phase have been updated, and/or the like, and send such information to management plane 280. The determination and/or sending of the progress information may occur periodically, based on request from the management plane 280, and/or the like. Accordingly, the management plane 280 may receive progress information from a number hosts 203 from the respective update agents 285.

In certain aspects, management plane 280 uses such progress information to display or send a progress report, such as to an administrator. The progress report may indicate, for example, which phase(s) are currently in progress, the percent completion of each phase (e.g., the percent of compute stack entities that have been updated among all compute stack entities to be updated in that phase), and/or the like. In certain aspects, compute stack entities may be associated with different categories at different hierarchical levels. For example, a given compute stack entity may be associated with a particular business unit at a company, while another compute stack entity may be associated with a different business unit. Further, different business units may be associated with different companies. In certain aspects, the progress report may indicate progress details at different hierarchical levels, such as at a business unit level, a company level, etc.

In certain aspects, management plane 280 is configured to manage update phases based on the progress information. For example, management plane 280 may be configured to start, pause, or stop cycles based on the progress information. The progress information may be indicative of a remaining risk to the overall system. For example, where a particular update phase is 30% complete, there remains a 70% risk that issues may arise with updates to the compute stack entities not yet updated during the phase. In certain aspects, management planc 280 may be configured to start update of a next phase, when a risk of a previous phase drops below a threshold (e.g., a threshold percentage of compute stack entities of the previous phase have been updated).

FIG. 5 is a flow diagram illustrating example operations 500 for determining update timing for a plurality of compute stack entities.

At block 505, management component determines, for each compute stack entity, which risk policy the compute stack entity is associated with, such as based on information received at blocks 305-325 of operations 300 of FIG. 3. Where a compute stack entity is associated with a single group, the risk policy associated with the single group is associated with the compute stack entity. Where the compute stack entity is associated with multiple groups, the risk policy associated with the highest priority group among the multiple groups is associated with the compute stack entity.

At block 510, management component determines (e.g., for cach risk policy individually) relative update timing for all compute stack entities associated with the risk policy. For example, the risk policy may indicate phases of update propagation for the compute stack entities associated with the particular risk policy. In certain aspects, the compute stack entities are assigned to the phases, such as according to the percentages associated with each phase. As an example, in a first phase, the risk policy may indicate to update 5% of the compute entities associated with the risk policy, in phase 2—20%, in phase 3—70%, and in phase 4—5%. In certain aspects, compute stack entities are assigned to phases by relative risk scores, such that lower risk score compute stack entities are updated in earlier phases in time, while higher risk score compute stack entities are updated in later phases in time. For example, compute stack entities may be ordered by relative risk scores and assigned to phases accordingly. The ordering may not be strict ordering, such as to make computation more efficient. In certain aspects, compute stack entities are assigned to phases randomly, or by some other suitable method or sorting criteria. For example, random assignment may be used by default where some other sorting criteria is not used.

At block 515, the management component determines a schedule (e.g., for each risk policy individually) for updating compute stack entities associated with the risk policy, such as by associating each of the phases with particular time windows. For example, phase 1 may be associated with a first time window that starts at a first start time and ends at a first end time. Phase 2 may be associated with a second time window that starts at a second start time and ends at a second end time, and the second start time starts after the first end time. Additional phases may similarly be associated with later time windows. In certain aspects, there is a delay between phases, as discussed. For example, there may be a delay between when the first time window ends and the second time window starts. For example, the delay may be of sufficient size to allow problems to arise before start of a next phase. In certain aspects, the start of a phase, such as the second time window, is based on the end time of another phase, such as the first time window, and is not a fixed time. For example, it may not be knowable how long the first phase will take, and therefore the end of the first time window is not known when starting the first phase. Accordingly, the second time window may be configured to start a certain delay time period after the first time window ends. In certain aspects, a timer is started with a duration of the delay time period when the first time window ends, and the second time window starts when the timer completes. The management component may than cause the compute stack entities to be updated according to the schedule, as described with respect to operations 300.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of risk aware updating of compute stack entities in an intended state configuration system, the method comprising:
receiving information of a plurality of compute stack entities;
receiving one or more group definitions defining one or more groups, each group of the one or more groups comprising one or more corresponding compute stack entities of the plurality of compute stack entities;
receiving information associating each of the one or more groups with a corresponding risk policy, each risk policy defining one or more phases for updating compute stack entities associated with the risk policy;
determining, for each of the one or more risk policies, corresponding one or more compute stack entities associated with the risk policy based on the information of the plurality of compute stack entities, the one or more group definitions, and the information associating each of the one or more groups with a corresponding risk policy;
determining, for each of the one or more risk policies, for each of the corresponding one or more compute stack entities associated with the risk policy, an update timing for updating the compute stack entity based on the risk policy;
modifying, for each compute stack entity of the plurality of compute stack entities, one or more manifest files at the determined update timing for updating the compute stack entity, wherein modifying the one or more manifest files causes the compute stack entity to be updated by a corresponding host monitoring the one or more manifest files.

2. The method of claim 1, further comprising sending an update directly to a first host to update a first compute stack entity different than the plurality of compute stack entities based on the first compute stack entity not being configured by the intended state configuration system.

3. The method of claim 2, wherein the update is sent to a first update agent of the first host, wherein the first update agent communicates the update to a second update agent on the first host having a privilege level to update the first compute stack entity, and wherein the first compute stack entity is updated by the second update agent.

4. The method of claim 1, wherein the information of a plurality of compute stack entities comprises, for each of the plurality of compute stack entities, a corresponding host identifier of a host running the compute stack entity, a corresponding type of compute stack entity, and a corresponding identifier of the compute stack entity.

5. The method of claim 4, wherein the corresponding type is one of a hypervisor, firmware, or application runtime.

6. The method of claim 1, further comprising receiving information regarding a priority order between the one or more groups, wherein the determining the corresponding one or more compute stack entities associated with the risk policy is further based on the priority order.

7. The method of claim 1, wherein determining the update timing for updating the compute stack entity is further based on a risk score associated with the compute stack entity as compared to risk scores of each of the plurality of compute stack entities.

8. The method of claim 1, wherein a first group definition of a plurality of group definitions indicates a first group includes any of the plurality of compute stack entities associated with one or more of a particular geographical location, a particular business unit, a particular company, a particular version number, or a particular type.

9. The method of claim 1, further comprising receiving, from one or more hosts, progress information regarding update of the plurality of compute stack entities, and one or more of:
displaying the progress information; or
determining the update timing for at least one compute stack entity further based on the progress information.

10. The method of claim 1, further comprising logging information indicating update of compute stack entities to a blockchain ledger.

11. The method of claim 1, further comprising using a blockchain based smart contract to receive authorization for updating the compute stack entities.

12. A computer system comprising at least one processor and memory configured to perform operations for risk aware updating of compute stack entities in an intended state configuration system, the operations comprising:
receiving information of a plurality of compute stack entities;
receiving one or more group definitions defining one or more groups, each group of the one or more groups comprising one or more corresponding compute stack entities of the plurality of compute stack entities;
receiving information associating each of the one or more groups with a corresponding risk policy, each risk policy defining one or more phases for updating compute stack entities associated with the risk policy;
determining, for each of the one or more risk policies, corresponding one or more compute stack entities associated with the risk policy based on the information of the plurality of compute stack entities, the one or more group definitions, and the information associating each of the one or more groups with a corresponding risk policy;
determining, for each of the one or more risk policies, for each of the corresponding one or more compute stack entities associated with the risk policy, an update timing for updating the compute stack entity based on the risk policy;
modifying, for each compute stack entity of the plurality of compute stack entities, one or more manifest files at the determined update timing for updating the compute stack entity, wherein modifying the one or more manifest files causes the compute stack entity to be updated by a corresponding host monitoring the one or more manifest files.

13. The computer system of claim 12, wherein the operations further comprise sending an update directly to a first host to update a first compute stack entity different than the plurality of compute stack entities based on the first compute stack entity not being configured by the intended state configuration system.

14. The computer system of claim 13, wherein the update is sent to a first update agent of the first host, wherein the first update agent communicates the update to a second update agent on the first host having a privilege level to update the first compute stack entity, and wherein the first compute stack entity is updated by the second update agent.

15. The computer system of claim 12, wherein the information of a plurality of compute stack entities comprises, for each of the plurality of compute stack entities, a corresponding host identifier of a host running the compute stack entity, a corresponding type of compute stack entity, and a corresponding identifier of the compute stack entity.

16. The computer system of claim 15, wherein the corresponding type is one of a hypervisor, firmware, or application runtime.

17. The computer system of claim 12, wherein the operations further comprise receiving information regarding a priority order between the one or more groups, wherein the determining the corresponding one or more compute stack entities associated with the risk policy is further based on the priority order.

18. The computer system of claim 12, wherein determining the update timing for updating the compute stack entity is further based on a risk score associated with the compute stack entity as compared to risk scores of each of the plurality of compute stack entities.

19. The computer system of claim 12, wherein a first group definition of a plurality of group definitions indicates a first group includes any of the plurality of compute stack entities associated with one or more of a particular geographical location, a particular business unit, a particular company, a particular version number, or a particular type.

20. A non-transitory computer readable medium storing instructions, which when executed by a computer system, cause the computer system to perform operations for risk aware updating of compute stack entities in an intended state configuration system, the operations comprising:
receiving information of a plurality of compute stack entities;
receiving one or more group definitions defining one or more groups, each group of the one or more groups comprising one or more corresponding compute stack entities of the plurality of compute stack entities;
receiving information associating each of the one or more groups with a corresponding risk policy, each risk policy defining one or more phases for updating compute stack entities associated with the risk policy;
determining, for each of the one or more risk policies, corresponding one or more compute stack entities associated with the risk policy based on the information of the plurality of compute stack entities, the one or more group definitions, and the information associating each of the one or more groups with a corresponding risk policy;
determining, for each of the one or more risk policies, for each of the corresponding one or more compute stack entities associated with the risk policy, an update timing for updating the compute stack entity based on the risk policy;
modifying, for each compute stack entity of the plurality of compute stack entities, one or more manifest files at the determined update timing for updating the compute stack entity, wherein modifying the one or more manifest files causes the compute stack entity to be updated by a corresponding host monitoring the one or more manifest files.
